(19) United States
(12) Patent Application Publication
(10) Pub. No.: US 2026/0022804 A1
(43) Pub. Date: Jan. 22, 2026

(54) CHRISTMAS LED BULB AND MANUFACTURING METHOD OF CHRISTMAS LED BULB

(71) Applicant: Hunan Zhida Technology Co., Ltd., Chenzhou (CN)

(72) Inventor: Li Chen, Hunan (CN)

(73) Assignee: Hunan Zhida Technology Co., Ltd., Chenzhou, HN (CN)

(21) Appl. No.: 18/844,016

(22) PCT Filed: Jul. 19, 2024
(86) PCT No.: PCT/CN2024/106425

§ 371 Date: Sep. 4, 2024

(51) Int. Cl. F21K 9/232; F21K 9/235; F21K 9/237; F21K 9/90; F21W 121/04; F21Y 115/10

(52) U.S. Cl. CPC F21K 9/232; F21K 9/235; F21K 9/237; F21K 9/90; F21W 2121/04; F21Y 2115/10

(57) ABSTRACT

A Christmas LED bulb and a manufacturing method of the Christmas LED bulb are disclosed, the Christmas LED bulb comprises: a housing made of glass material, a bottom end of the housing being provided with an opening; a bottom cover made of insulating material, the bottom cover being fixedly connected to two electric conductors arranged at an interval, and two ends of the electric conductor respectively protruding from two end surfaces of the bottom cover; and a light-emitting LED connected to the electric conductors respectively for electric conduction and light emission; and the bottom cover is inserted and matched with the housing, so as to drive the light-emitting LED to pass through the opening to be placed in the housing, and the bottom cover and the housing are adhered and connected through an adhesive.

### CROSS-REFERENCE TO RELATED APPLICATION

This application is a national stage filing under 35 U.S.C. § 371 of international application number PCT/CN2024/106425, filed Jul. 19, 2024, titled CHRISTMAS LED BULB AND MANUFACTURING METHOD OF CHRISTMAS LED BULB. The contents of this international application are incorporated herein by reference in its entirety.

### TECHNICAL FIELD

The present disclosure relates to the technical field of Christmas lamps, and particularly to a Christmas LED bulb and a manufacturing method of the Christmas LED bulb.

### BACKGROUND

In recent years, with the rapid development of semiconductor lighting technology, a light-emitting diode bulb has gradually become the mainstream product in the lighting field because of the advantages of energy saving, environmental protection and long service life. Especially in the aspects of holiday decoration, commercial exhibition and home lighting, the LED bulb is increasingly widely applied, wherein the market demand for the Christmas LED bulb as a representative of holiday decoration continues to grow.

In the existing technology, most of the traditional manufacturing technologies of the LED bulb follow some production processes of an early incandescent bulb, especially in the aspect of lamp body packaging, a high-temperature welding technology is generally adopted, that is, pins (such as Dumet wires) are hermetically connected to a glass lamp body by flame heating and melting of glass. However, this method has following obvious limitations and disadvantages:
1. protection of heat-sensitive element: a LED chip is extremely sensitive to temperature, even if protective measures are taken during high-temperature treatment, it is still difficult to completely avoid an influence of a thermal stress on performance and service life of the LED, which may lead to the problems of accelerated light attenuation, color offset, and the like;
2. risk of short circuit: in a process of glass melting and sealing, it is a challenge to control a precise position of the pin to avoid short circuit, and any slight deviation may cause pin contact, so as to form the short circuit in a circuit, thus affecting the normal operation of the bulb;
3. limitations of material and process: a traditional melting and sealing technology limits the selection of pin materials, and materials compatible with glass are usually adopted, which not only limits the design flexibility, but also may increase the cost; and
4. obstacle to automated production: the high-temperature treatment process is difficult to be compatible with a modern automated production line, and a proportion of manual operation is high, which affects the consistency of production efficiency and product quality, thus being difficult to meet the needs of mass customization and rapid response to the market.

In view of the above problems, the industry urgently needs a new LED bulb structure design and a manufacturing method thereof, so as to solve the problems of thermal damage, short circuit risk, material limitation and difficult automated production in the existing technology, and promote the development of the LED lighting technology in a more efficient, safe, flexible and intelligent direction.

### SUMMARY

The present disclosure aims to solve at least one of the technical problems in the existing technology. Therefore, the present disclosure provides a Christmas LED bulb, where split type design and adhesive connection are adopted in the Christmas LED bulb. On this basis, a LED element is effectively protected from thermal damage, the risk of short circuit is eliminated, the selection of pins made of multiple materials is supported, an automatic assembly process is optimized, the production efficiency and flexibility are significantly improved, the requirement of mass production is satisfied, the innovation is brought to a LED bulb manufacturing industry, and the advantages of safety, efficiency and economy are achieved at the same time.

The present disclosure further provides a manufacturing method of the Christmas LED bulb above.

The Christmas LED bulb according to the present disclosure comprises:
a housing made of glass material, where a bottom end of the housing is provided with an opening;
a bottom cover made of insulating material, where the bottom cover is fixedly “connected to two electric conductors arranged at an interval, and two ends of the electric conductor respectively protrude from two end surfaces of the bottom cover; and
a light-emitting LED connected to the electric conductors respectively for electric conduction and light emission;
wherein the bottom cover is inserted and matched with the housing, so as to drive the light-emitting LED to pass through the opening to be placed in the housing, and the bottom cover and the housing are adhered and connected through an adhesive.

The Christmas LED bulb according to the present disclosure has at least the following beneficial effects: traditional high-temperature fusion is replaced by the adhesive connection between the bottom cover and the housing, so that a potential damage of high temperature to the LED is completely eliminated, an electrical performance and an optical characteristic of the LED are protected, and the service life of the bulb is prolonged; moreover, because the two electric conductors arranged at an interval are fixed on the bottom cover, a short circuit phenomenon between the pins is effectively prevented, and the electrical safety and stability of the bulb are improved. In addition, the split design mode facilitates the modular design and automatic assembly of the LED bulb, promotes the improvement of production efficiency, is especially suitable for a high-yield manufacturing need, reduces production costs, and enhances market competitiveness.

According to the Christmas LED bulb in some embodiments of the present disclosure, an inner side of the bottom cover is provided with a glue injection groove, and the bottom end of the housing is inserted into the glue injection groove and fixed by the adhesive in the glue injection groove.

According to the Christmas LED bulb in some embodiments of the present disclosure, a joint between the housing and the bottom cover is in a circular structure.

According to the Christmas LED bulb in some embodiments of the present disclosure, an outer wall of the housing is in smooth transition connection with an outer wall of the bottom cover.

According to the Christmas LED bulb in some embodiments of the present disclosure, the bottom cover is made of glass material.

According to the Christmas LED bulb in some embodiments of the present disclosure, the bottom cover is made of elastic material, an outline of the bottom cover is matched with a shape of the opening, the bottom cover is in interference fit with the inner wall of the housing, and the bottom cover and the housing are hermetically connected by the adhesive.

According to the Christmas LED bulb in some embodiments of the present disclosure, the housing comprises an extending portion and a light expanding portion, an end of the extending portion is used for connecting with the bottom cover, the light-emitting LED is located above the extending portion and placed in the light expanding portion, and a maximum outer diameter of the light expanding portion is greater than that of the extending portion.

According to the Christmas LED bulb in some embodiments of the present disclosure, the light-emitting LED is a patch LED.

According to the Christmas LED bulb in some embodiments of the present disclosure, the electric conductor comprises a vertical section and an inclined section communicated with each other, a center line of the vertical section is parallel to a center line of the housing, the inclined section is obliquely arranged with the vertical section, and the light-emitting LED is mounted on the inclined section to emit light towards a top portion of the housing.

The manufacturing method of the Christmas LED bulb according to the present disclosure comprises the Christmas LED bulb of the present invention, and comprises the following steps of: manufacturing the housing: using glass as a raw material to manufacture the housing; assembling the electric conductors: using glass as a raw material, heating and melting the glass, and positioning and placing the two electric conductors to integrally form the bottom cover and the electric conductors; assembling the light-emitting LED: after assembling the electric conductors, subjecting the electric conductors to patch processing, and connecting the light-emitting LED to the electric conductors; and assembling the bulb: after manufacturing the housing and assembling the light-emitting LED, inserting the bottom cover and the housing by position alignment, and fixing the bottom cover and the housing by glue in the glue injection groove.

The manufacturing method of the Christmas LED bulb according to the present disclosure has at least the following beneficial effects: by using the glue injection and fixation technology, it not only simplifies the complex links in a traditional manufacturing process and reduces production costs, but also effectively avoids potential safety hazards caused by high-temperature operation and improves the production safety and environmental protection, so that the production efficiency and product quality are greatly promoted as a whole.

Additional aspects and advantages of the present invention will be given in part in the following description, which will become apparent from the following description or be understood through practice of the present disclosure.

### BRIEF DESCRIPTION OF THE DRAWINGS

The above and/or additional aspects and advantages of the present disclosure will become apparent and easy to understand from the descriptions of embodiments with reference to the following drawings, wherein:

FIG. 1 is an exploded view of a Christmas LED bulb in an embodiment of the present disclosure;

FIG. 2 is a schematic diagram of a cross-section structure of the Christmas LED bulb in the embodiment of the present disclosure;

FIG. 3 is a schematic diagram of an overall structure of a Christmas LED bulb in another embodiment of the present disclosure;

FIG. 4 is a schematic diagram of an overall structure of a Christmas LED bulb in another embodiment of the present disclosure; and

FIG. 5 is a flow chart of a manufacturing method of a Christmas LED bulb in the embodiment of the present disclosure.

### DETAILED DESCRIPTION

Embodiments of the present disclosure are described in detail hereinafter, examples of the embodiments are shown in the drawings, and the same or similar reference numerals throughout the drawings denote the same or similar elements or elements having the same or similar functions. The embodiments described hereinafter with reference to the drawings are exemplary, are only intended to explain the present invention disclosure, and cannot be understood as limiting the present invention.

In the description of the present disclosure, it should be understood that, the orientation or position relationship related to the orientation description, such as the orientation or position relationship indicated by the terms “upper”, “lower”, “front”, “rear”, “left”, “right”, and the like is based on the orientation or position relationship shown in the drawings, which is only used for convenience of the description of the present disclosure and simplification of the description instead of indicating or implying that the indicated device or element must have a specific orientation, and be constructed and operated in a specific orientation, and thus should not be understood as a limitation to the present disclosure.

In the description of the present disclosure, the meaning of several refers to being one or more, and the meaning of multiple refers to being more than two. The meanings of greater than, less than, more than, etc., are understood as not comprising this number, while the meanings of above, below, within, etc., are understood as comprising this number. If there is the description of first and second, it is only for the purpose of distinguishing technical features, and should not be understood as indicating or implying relative importance, implicitly indicating the number of the indicated technical features or implicitly indicating the order of the indicated technical features.

In the description of the present disclosure, unless otherwise explicitly defined, the terms “setting”, “mounting” and “connecting” should be understood a broad sense, and those skilled in the art can reasonably determine the specific meanings of the above terms in the present disclosure in combination with the specific contents of the technical solution.

In the description of the present disclosure the descriptions of the reference terms “one embodiment”, “some embodiments”, “schematic embodiments”, “examples”, “specific examples”, or “some examples” refer to that the specific features, structures, materials, or characteristics described in combination with the embodiment or example are included in at least one embodiment or example of the present disclosure. In the specification, the schematic representation of the above terms does not necessarily mean the same embodiment or example. Moreover, the specific features, structures, materials or characteristics described can be combined in any one or more embodiments or examples in a suitable manner.

In recent years, with the rapid development of semiconductor lighting technology, a light-emitting diode bulb has gradually become the mainstream product in the lighting field because of the advantages of energy saving, environmental protection and long service life. Especially in the aspects of holiday decoration, commercial exhibition and home lighting, the LED bulb is increasingly widely applied, where the market demand for the Christmas LED bulb as a representative of holiday decoration continues to grow.

In the existing technology, most of the traditional manufacturing technologies of the LED bulb follow some production processes of an early incandescent bulb, especially in the aspect of lamp body packaging, a high-temperature welding technology is generally adopted, that is, pins (such as Dumet wires) are hermetically connected to a glass lamp body by flame heating and melting of glass. However, this method has several obvious limitations and disadvantages:
1. Protection of heat-sensitive element: a LED chip is extremely sensitive to temperature, even if protective measures are taken during high-temperature treatment, it is still difficult to completely avoid an influence of a thermal stress on performance and service life of the LED, which may lead to the problems of accelerated light attenuation, color offset, and the like;
2. Risk of short circuit: in a process of glass melting and sealing, it is a challenge to control a precise position of the pin to avoid short circuit, and any slight deviation may cause pin contact, so as to form the short circuit in a circuit, thus affecting the normal operation of the bulb;
3. Limitations of material and process: a traditional melting and sealing technology limits the selection of pin materials, and materials compatible with glass are usually adopted, which not only limits the design flexibility, but also may increase the cost; and
4. Obstacle to automated production: the high-temperature treatment process is difficult to be compatible with a modern automated production line, and a proportion of manual operation is high, which affects the consistency of production efficiency and product quality, thus being difficult to meet the needs of mass customization and rapid response to the market.

In view of the above problems, the industry urgently needs a new LED bulb structure design and a manufacturing method thereof, so as to solve the problems of thermal damage, short circuit risk, material limitation and difficult automated production in the existing technology, and promote the LED lighting technology to be efficient, safe, flexible and intelligent.

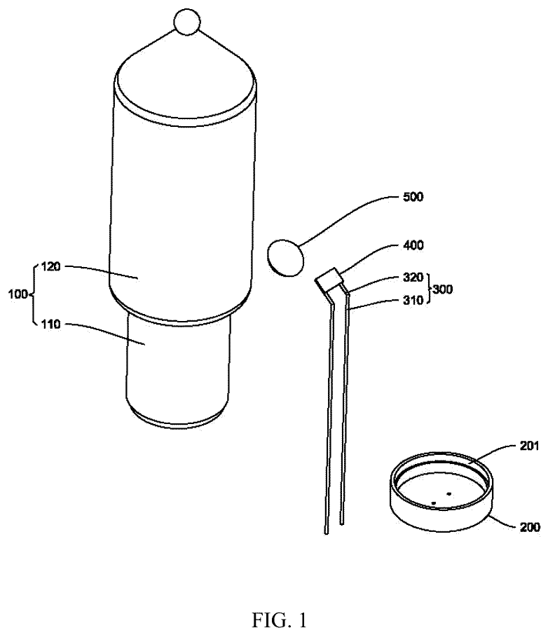

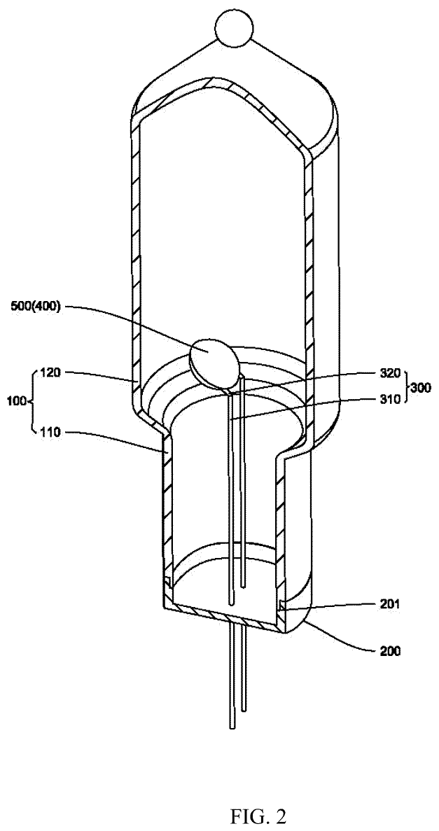

As shown in FIG. 1 and FIG. 2, a Christmas LED bulb provided by the present disclosure comprises a housing 100, a bottom cover 200, an electric conductor 300 and a light-emitting LED 400. The housing 100 is made of glass material, and the bottom cover 200 is made of insulating material. Two electric conductors 300 are arranged at an interval on the bottom cover 200 and fixedly connected to the bottom cover 200, two ends of the electric conductor 300 respectively protrude from two end surfaces of the bottom cover 200, and the light-emitting LED 400 is connected to the electric conductors 300 respectively for electric conduction and light emission. Specifically, a bottom end of the housing 100 is provided with an opening 101, the bottom cover 200 is inserted and matched with the housing 100, so as to drive the light-emitting LED 400 to pass through the opening 101 to be placed in the housing 100, and the bottom cover 200 and the housing 100 are adhered and connected through an adhesive. The common adhesive is glue. It should be noted that traditional high-temperature fusion is replaced by the adhesive connection between the bottom cover 200 and the housing 100, so that a potential damage of high temperature to the LED is completely eliminated, an electrical performance and an optical characteristic of the LED are protected, and the service life of the bulb is prolonged; moreover, because the two electric conductors 300 arranged at an interval are fixed on the bottom cover 200, a short circuit phenomenon between the pins is effectively prevented, and the electrical safety and stability of the bulb are improved. In addition, the split design mode facilitates the modular design and automatic assembly of the LED bulb, promotes the improvement of production efficiency, is especially suitable for a high-yield manufacturing need, reduces production costs, and enhances market competitiveness.

Optionally, the light-emitting LED 400 is a patch LED, which improves the integration. Moreover, a high-efficiency heat dissipation characteristic and a lighting effect of the patch LED make the bulb more energy-saving, and it is convenient for automated production at the same time, thereby improving the production efficiency and consistency. In some applications, after the light-emitting LED 400 is connected to the electric conductors 300, an outer surface of the light-emitting LED 400 is wrapped with protective glue 500, which can protect the light-emitting LED 400 from external damage, and make the connection between the light-emitting LED 400 and the electric conductors 300 more stable.

In some existing technologies, the patch LED in the Christmas LED bulb is laterally mounted on metal wires in the bulb. When in use, the patch LED emits light unilaterally towards a peripheral wall of the housing, which cannot form a stereoscopic lighting effect, resulting in bad using experience. Therefore, in some embodiments of the present disclosure, with reference to FIG. 2, the electric conductor 300 comprises a vertical section 310 and an inclined section 320 communicated with each other, a center line of the vertical section 310 is parallel to a center line of the housing 100, the inclined section 320 is obliquely arranged with the vertical section 310, and the light-emitting LED 400 is mounted on the inclined section 320 to emit light towards a top portion of the housing 100. Furthermore, the light-emitting LED 400 emits light towards the top portion, which can achieve a stereoscopic lighting effect, resulting in good using experience. Optionally, the inclined section 320 and the vertical section 310 form an included angle of 30° to 60°, for example, the included angle between the inclined section 320 and the vertical section 310 is 45°. In some embodiments, the included angle between the inclined section and the vertical section is 90° (not shown in the drawings). That is, the inclined section 320 is vertically arranged with the vertical section 310, and the light-emitting LED 400 emits light towards the top portion of the housing 100. It should be noted that the common electric conductor 300 comprises a copper wire, a silver wire, a platinum wire, a Dumet wire and other metal wires.

In some embodiments, an insertion positioning structure is arranged between the housing 100 and the bottom cover 200, which can control an insertion depth. With reference to FIG. 1 and FIG. 2, in some embodiments of the present disclosure, an inner side of the bottom cover 200 is provided with a glue injection groove 201, and the bottom end of the housing 100 is inserted into the glue injection groove 201 and fixed by the adhesive in the glue injection groove 201. The built-in design of the adhesive can ensure an effect after assembly, and prevent the adhesive from being damaged by external factors. Moreover, the design of the glue injection groove 201 can better fix the housing 100 and the bottom cover 200 by using the adhesive, so that a more accurate and reliable sealing effect is achieved, and waterproof and dustproof performances of the bulb are improved, thus prolonging the service life. Further, a joint between the housing 100 and the bottom cover 200 is in a circular structure. Compared with a square or angular alignment structure, the circular structure is more convenient for position alignment, which further improves the convenience of assembly. Moreover, the design of the circular structure can effectively disperse a stress, and reduce the risk of damage caused by an excessive local stress, thus improving the overall mechanical strength and stability of the bulb. In addition, in some embodiments of the present disclosure, an outer wall of the housing 100 is in smooth transition connection with an outer wall of the bottom cover 200, which not only improves the smoothness and aesthetics of appearance, but also improves the optical performance of the bulb, such as reducing a refraction loss of light, and making light output more uniform and softer, thereby improving the lighting quality. Meanwhile, a smooth surface is easy to clean and maintain.

Optionally, the bottom cover 200 is made of glass material, which is same as the material of the housing 100, so that the transparency and visual beauty of the bulb can be ensured, thus it is suitable for lighting scenes requiring high light transmittance. In addition, the glass material also has excellent insulation and high hardness, and will not age, so that the electrical safety is ensured, and an application range of the bulb is widened.

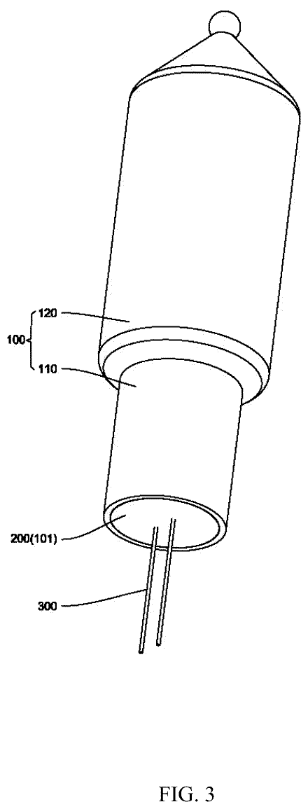

With reference to FIG. 3, in some embodiments of the present disclosure, the bottom cover 200 is inserted and matched with an inner wall of the housing 100. Specifically, the bottom cover 200 is made of elastic material, an outline of the bottom cover 200 is matched with a shape of the opening 101, the bottom cover 200 is in interference fit with the inner wall of the housing 100, and the bottom cover 200 and the housing 100 are hermetically connected by the adhesive. The bottom cover 200 is tightly connected to the housing 100 through interference fit and sealed by the adhesive, which not only simplifies assembly steps and improves the production efficiency, but also improves an anti-vibration ability and a sealing performance of the bulb, thereby being especially suitable for use in dynamic environment, and improving the stability and reliability of the bulb. In some applications, the adhesive is coated on a joint between the bottom cover 200 and the bottom surface of the housing 100, and forms a film layer after drying, so as to seal the joint between the bottom cover 200 and the bottom surface of the housing 100. Alternatively, the adhesive is coated on the bottom cover 200 and the whole bottom surface of the housing 100, and forms film layers after drying, so as to seal a whole bottom surface of the bulb. Optionally, the bottom cover 200 is completely inserted into the housing 100, and the assembled bottom cover 200 is not easy to be pulled out by contact, so that the integrity of the product is great.

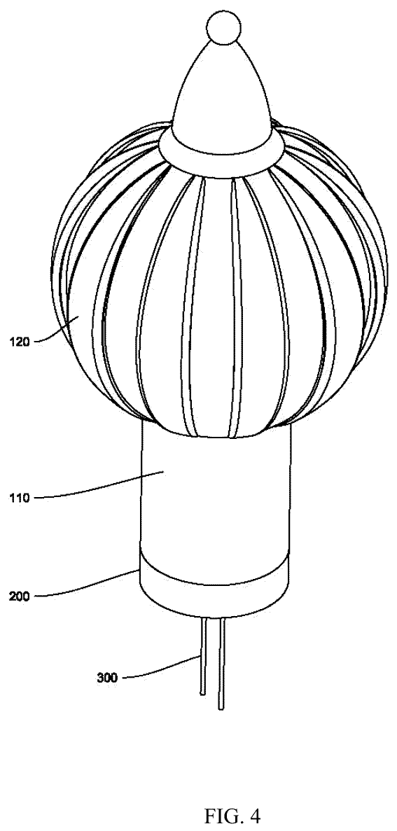

With reference to FIG. 4, in some embodiments of the present disclosure, the housing 100 comprises an extending portion 110 and a light expanding portion 120, an end of the extending portion 110 is used for connecting with the bottom cover 200, the light-emitting LED 400 is located above the extending portion 110 and placed in the light expanding portion 120, and a maximum outer diameter of the light expanding portion 120 is greater than that of the extending portion 110. Therefore, not only an internal space is reasonably arranged to facilitate the mounting and heat dissipation of the LED 400, but also the diameter enlargement design of the light expanding portion 120 is adopted to effectively enhance light divergence and improve the lighting effect, so that light distribution is uniform, thereby improving the comfort and practicability of lighting. The conventional Christmas LED bulb is in a cylindrical structure with a constant outer diameter, and has a single shape. In some embodiments of the present disclosure, the light expanding portion 120 can be designed into various shapes, such as a lantern shape and a fruit shape, so that the shapes can be abundant, which can match the atmospheres in festivals.

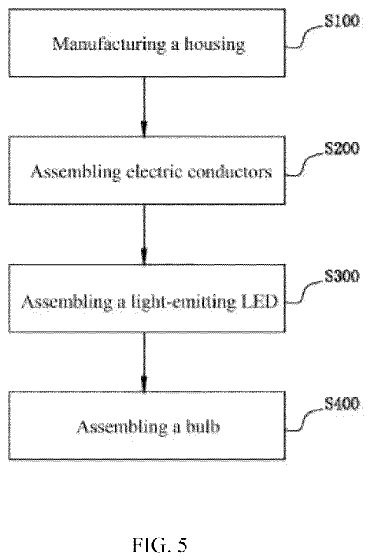

With reference to FIG. 5, the manufacturing method of the Christmas LED bulb in the embodiment of the present disclosure comprises the Christmas LED bulb in the embodiment of the present disclosure, and specifically, the manufacturing method comprises the following sequentially executed steps of:
S100. manufacturing the housing 100: using glass as a raw material to manufacture the housing 100;
S200. assembling the electric conductors 300: using glass as a raw material, heating and melting the glass, and positioning and placing the two electric conductors 300 to integrally form the bottom cover 200 and the electric conductors 300;
S300. assembling the light-emitting LED 400: after assembling the electric conductors 300, subjecting the electric conductors 300 to patch processing, and connecting the light-emitting LED 400 to the electric conductors 300; and
S400. assembling the bulb: after manufacturing the housing 100 and assembling the light-emitting LED 400, inserting the bottom cover 200 and the housing 100 by position alignment, and fixing the bottom cover and the housing by glue in the glue injection groove 201.

According to the manufacturing method of the Christmas LED bulb in the embodiment of the present disclosure, by using the Christmas LED bulb in the embodiment of the present disclosure and the glue injection and fixation technology, it not only simplifies the complex links in a traditional manufacturing process and reduces production costs, but also effectively avoids potential safety hazards caused by high-temperature operation and improves the production safety and environmental protection, so that the production efficiency and product quality are greatly promoted as a whole.

Other components and operations of the manufacturing method of the Christmas LED bulb in the embodiment of the present disclosure are all known to those of ordinary skills in the art, which will not be described in detail herein.

The embodiments of the present disclosure are described in detail with reference to the drawings above, but the present disclosure is not limited to the above embodiments, and various changes can also be made within the knowledge scope of those of ordinary skills in the art without departing from the purpose of the present disclosure.

1. A Christmas LED bulb, comprising:
a housing made of glass material, wherein a bottom end of the housing is provided with an opening;
a bottom cover made of insulating material, wherein the bottom cover is fixedly connected to two electric conductors arranged at an interval, and two ends of the electric conductor respectively protrude from two end surfaces of the bottom cover; and
patch LED connected to the electric conductors respectively for electric conduction and light emission;
wherein the bottom cover is inserted and matched with the housing, an outer wall of the housing is in a smooth transition connection with an outer wall of the bottom cover, and a joint between the housing and the bottom cover is in a circular structure, so as to drive the patch LED to pass through the opening to be placed in the housing, and the bottom cover and the housing are adhered and connected through an adhesive;
wherein an inner side of the bottom cover is provided with a glue injection groove, and the bottom end of the housing is inserted into the glue injection groove and fixed by the adhesive in the glue injection groove; and
wherein the electric conductor comprises a vertical section and an inclined section communicated with each other, a center line of the vertical section is parallel to a center line of the housing, the inclined section is obliquely arranged with the vertical section, and the patch LED is mounted on the inclined section, such that an included angle of 30° to 60° is formed between the patch LED and the center line of the housing.

2-4. (canceled)

5. The Christmas LED bulb according to claim 1, wherein the bottom cover is made of glass material.

6. (canceled)

7. The Christmas LED bulb according to claim 1, wherein the housing comprises an extending portion and a light expanding portion, an end of the extending portion is used for connecting with the bottom cover, the light-emitting LED is located above the extending portion and placed in the light expanding portion, and a maximum outer diameter of the light expanding portion is greater than that of the extending portion.

8-15. (canceled)

16. The Christmas LED bulb according to claim 1, wherein the included angle is 45°.
